(19) United States
(12) Patent Application Publication
(10) Pub. No.: US 2026/0099304 A1
(43) Pub. Date: Apr. 9, 2026

(54) TECHNIQUES FOR CLOSED-LOOP CODE GENERATION FOR ROBOT CONTROL

(71) Applicant: NVIDIA CORPORATION, Santa Clara, CA (US)

(72) Inventors: Valts BLUKIS, Seattle, WA (US); Alexander ZOOK, Irvine, CA (US); Stanley BIRCHFIELD, Sammamish, WA (US); Balakumar SUNDARALINGAM, San Jose, CA (US); Jonathan TREMBLAY, Redmond, WA (US)

(21) Appl. No.: 19/249,907

(22) Filed: Jun. 25, 2025

Related U.S. Application Data
(60) Provisional application No. 63/703,093, filed on Oct. 3, 2024.

(51) Int. Cl. G06F 8/35; G06F 11/362; G06V 10/26; G06V 10/70; G06V 20/50; G06V 20/64; G06V 20/70

(52) U.S. Cl. CPC G06F 8/35; G06F 11/3636; G06V 10/26; G06V 10/70; G06V 20/50; G06V 20/64; G06V 20/70

(57) ABSTRACT

One embodiment of a method for processing data includes receiving an image; segmenting, using a first trained machine learning model, the image to generate a segmentation mask; generating one or more descriptions of one or more objects using a second machine learning model and based on the segmentation mask; generating program code using a third trained machine learning model and based on the one or more descriptions, the image, and a task; and causing a robot to move based on the program code.

### CROSS-REFERENCE TO RELATED APPLICATIONS

This application claims priority benefit of the United States Provisional Patent Application titled, “ANALOG REAL ROBOT FOR REASONING, PLANNING, AND REACTING,” filed on Oct. 3, 2024, and having Ser. No. 63/703,093. The subject matter of this related application is hereby incorporated herein by reference.

### BACKGROUND

### Field of the Various Embodiments

The various embodiments relate generally to computer science, robotics, machine learning and artificial intelligence (AI), and, more specifically, to techniques for closed-loop code generation for robot control.

### Description of the Related Art

Vision-based robot control uses cameras and other imaging sensors to guide robotic systems in both structured and unstructured environments. By processing visual information—such as red, green, and blue (RGB) images, depth maps, and/or point clouds—robots can perceive objects, monitor the surroundings, and perform tasks. Vision-based robot control supports a variety of tasks, from grasping and moving objects to assembling parts and interacting with complex scenes. Vision-based robot control often uses machine learning algorithms that interpret camera data to detect obstacles, plan movements, and execute smooth, collision-free robot trajectories.

One conventional approach for vision-based robot control uses a generative artificial intelligence (AI) model to generate program code that, when executed, controls a robot to perform a task. Generative AI models are machine learning models that are trained from existing data to create new content. The new content can include text, such as program code for controlling a robot.

One drawback when using generative AI models for vision-based robot control is the lack of perception systems that are capable of correctly understanding all of the relevant objects in a scene. When the relevant objects in a scene are not identified correctly, a generative AI model can generate program code that controls a robot to interact with the wrong objects, or that otherwise fails to correctly control the robot to perform a task.

Another drawback when using generative AI models for vision-based robot control is that the generated program code is oftentimes not robust to changes in the environment or failures during execution of the program code. Take for example program code that is generated for controlling a robot to pick up and move an object to a different location. Failures encountered during execution of such program code can include the robot being unable to pick up the object or dropping the object after picking up the object. Changes in the environment can include objects being moved by a human or otherwise disturbed from the expected locations of those objects. When such failures or changes in the environment are encountered, execution of the remaining program code to control the robot will not achieve the desired goal of moving the object to the different location. Notably, program code that is generated using conventional approaches typically cannot adapt to such failures or changes in the environment.

As the foregoing illustrates, what is needed in the art are more effective techniques for controlling robots.

### SUMMARY

One embodiment of the present disclosure sets forth a computer-implemented method for robot control. The method includes receiving an image, and segmenting, using a first trained machine learning model, the image to generate a segmentation mask. The method also includes generating one or more descriptions of one or more objects using a second machine learning model and based on the segmentation mask. The method further includes generating program code using a third trained machine learning model and based on the one or more descriptions, the image, and a task. In addition, the method includes causing a robot to move based on the program code.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that, with the disclosed techniques, relevant objects in a scene can be correctly identified and added to a scene description that permits a multimodal model to generate program code for controlling a robot. Another advantage of the disclosed techniques is that, during execution of the program code, the world state is verified based on updated scene descriptions, and program code for controlling the robot is regenerated when the verification is unsuccessful. Accordingly, the robot control can adapt to disturbances in the environment and failures during execution of the program code. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a more detailed illustration of the robot control application of FIG. 1, according to various embodiments;

FIG. 5 is a more detailed illustration of the scene comprehension module of FIG. 4, according to various embodiments;

FIG. 6 illustrates an exemplar prompt that the scene comprehension module can input into the vision-language model of FIG. 5, according to various embodiments;

FIG. 7 illustrates an exemplar scene description, according to various embodiments;

FIG. 8 is a more detailed illustration of the code generation module, the scene tracking module, and the replanning module of FIG. 4, according to various embodiments;

FIG. 9 illustrates an exemplar prompt that the code generation module can input into the multimodal model of FIG. 8, according to various embodiments;

FIG. 10 is a more detailed illustration of the scene tracking module of FIG. 4, according to various embodiments;

FIG. 11 illustrates an exemplar prompt that the assertion module can input into the multimodal model of FIG. 8, according to various embodiments;

FIG. 12 illustrates exemplar replanning by the robot control application of FIG. 1 to recover from a disruption, according to various embodiments; and

FIG. 13 is a flow diagram of method steps for controlling a robot, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for controlling robots to perform tasks. In some embodiments, a robot control application receives as input a task as well as image and three-dimensional (3D) information of an environment that includes a robot. The task can be a natural language description of a goal to achieve or problem to address, such as “Place all of the fruits in a bin,” which requires the robot control application to reason about which objects in the image and 3D information are fruits and bins and figure out how to control the robot to perform the task. The robot control application uses a segmentation model to segment the received image and generate a segmentation mask. The robot control application prompts a vision-language model (VLM) to describe each object, identified using the segmentation mask, that is manipulable in the received image. The robot control application generates a scene description that includes a description and spatial representation of each object. Then, the robot control application processes the image, the scene description, and the task using a multimodal model to generate robot code. The robot control application performs a mock execution of the robot code to check for errors. If the mock execution results in an error, then the robot control application regenerates robot code using the multimodal model. On the other hand, if the mock execution does not result in an error, then the robot control application causes the robot code to be executed to control a robot. During execution of the robot code, the robot control application can receive an additional image and 3D information. Given the additional image and 3D information, the robot control application generates an updated scene description that includes a description and updated spatial representation of each object. When code for an assertion is reached in the robot code, the robot control application also generates verification code using the multimodal model to verify the world state, which can be used to verify that the task is progressing (e.g., the robot has picked up an object during a pick-and-place task). If the verification fails, then the robot control application generates new robot code based on the current world state and controls the robot using the new robot code. On the other hand, if the verification succeeds, then the robot control application permits the robot code to continue executing to control the robot.

The techniques for controlling robots have many real-world applications. For example, the techniques can be used to control a robot in a real or virtual environment, such as an industrial environment, a home environment, a manufacturing environment, a video game environment, or the like.

The above examples are not in any way intended to be limiting. As persons skilled in the art will appreciate, as a general matter, the techniques for controlling robots described herein can be implemented anywhere that robot control is required or useful.

### System Overview

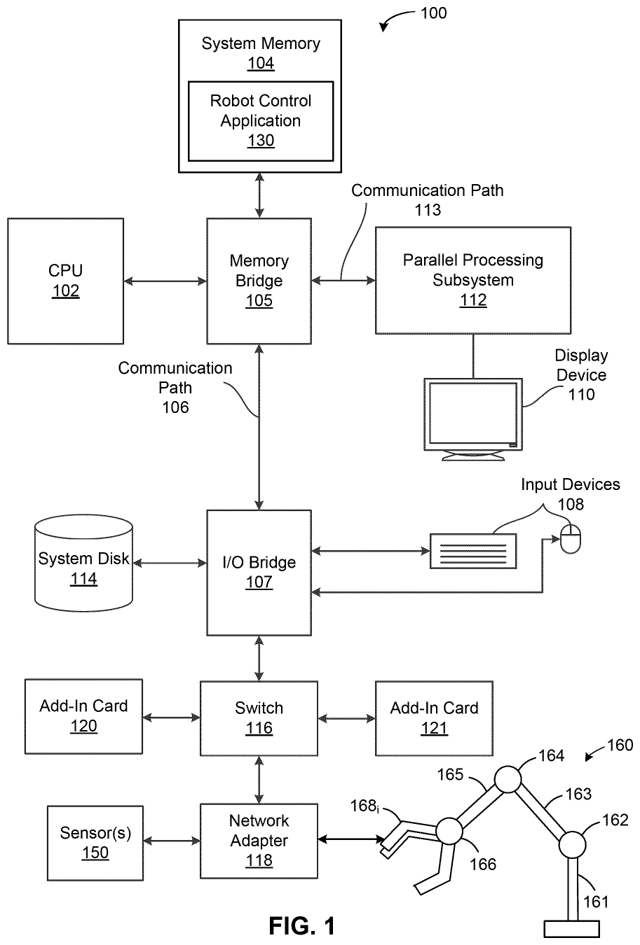

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113.

Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

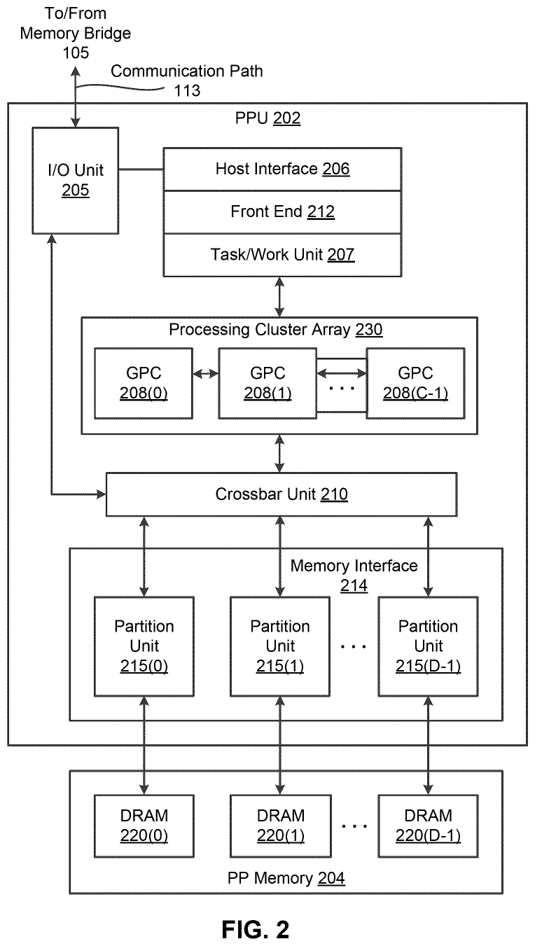

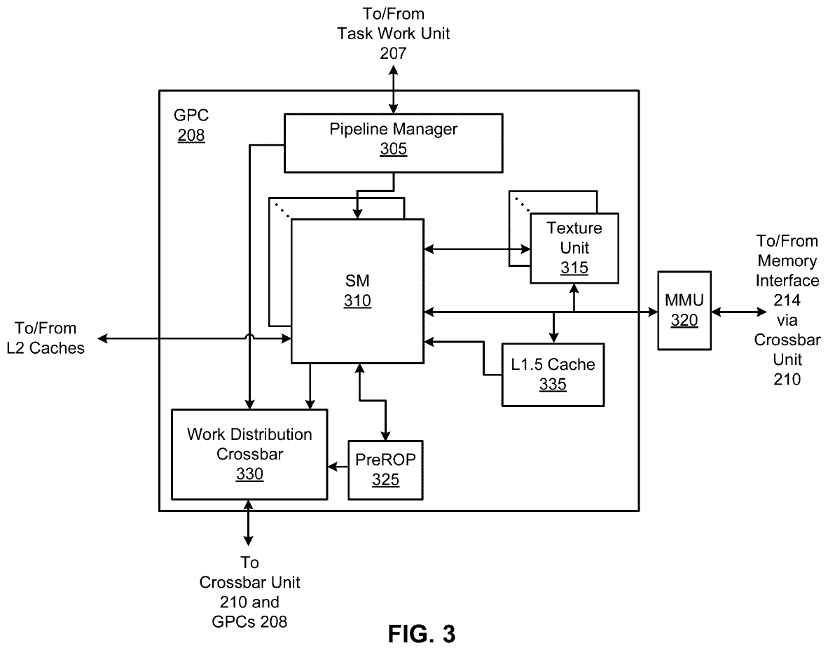

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

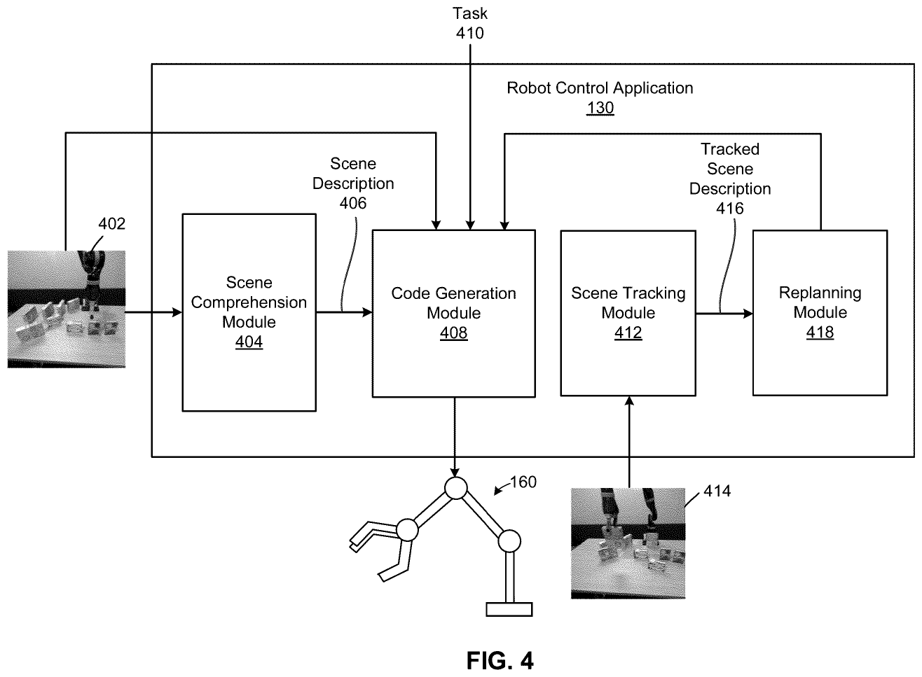

Illustratively, system memory 104 stores a robot control application 130. Robot control application 130 is configured to control a robot 160 to perform one or more tasks. In some embodiments, given sensor data acquired using one or more sensors 150, such as images captured by one or more cameras, 3D information (e.g., depth data) acquired using one or more depth sensors, etc., robot control application 130 can generate program code that executes to control robot 160, as discussed in greater detail below in conjunction with FIGS. 4-13. Although described herein primarily with respect to robot control application 130 as a reference example, techniques disclosed herein can also be implemented, either entirely or in part, in other software and/or hardware, such as in parallel processing subsystem 112.

As shown, robot 160 includes multiple links 161, 163, and 165 that are rigid members, as well as joints 162, 164, and 166 that are movable components that can be actuated to cause relative motion between adjacent links. In addition, robot 160 includes multiple fingers 168ᵢ (referred to herein collectively as fingers 168 and individually as a finger 168) that can be controlled to grip an object. Although an example robot 160 is shown for illustrative purposes, in some embodiments, techniques disclosed herein can be applied to control any suitable robot.

In various embodiments, parallel processing subsystem 112 may be integrated with one or more of the other elements of FIG. 1 to form a single system.

For example, parallel processing subsystem 112 may be integrated with CPU 102 and other connection circuitry on a single chip to form a system on chip (SoC)

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 118.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task.

Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.).

Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array. ” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Closed-Loop Code Generation for Robot Control

FIG. 4 is a more detailed illustration of the robot control application 130 of FIG. 1, according to various embodiments. As shown, the robot control application 130 includes, without limitation, a scene comprehension module 404, a code generation module 408, a scene tracking module 412, and a replanning module 418. In operation, the robot control application 130 receives sensor data 402 and a task 410. In some embodiments, the sensor data 402 includes image and three-dimensional (3D) information, such as one or more RGB-D (red, green, blue, depth) images. The task 410 is a natural language description of a task for the robot 160 to perform, such as “Move the object that is immediately to the right of the corn to a vacant space left of the corn.” In some embodiments, the task 410 can be described in natural language text included in a prompt that is input by a user via, e.g., a user interface (UI).

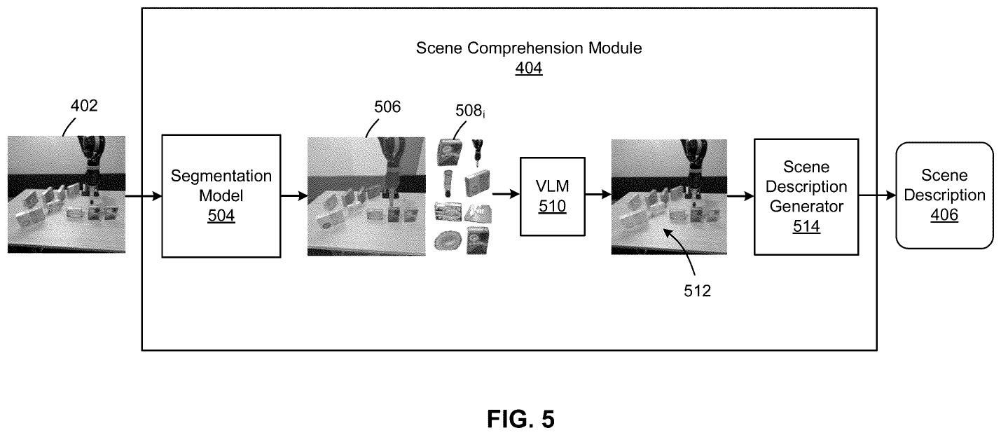

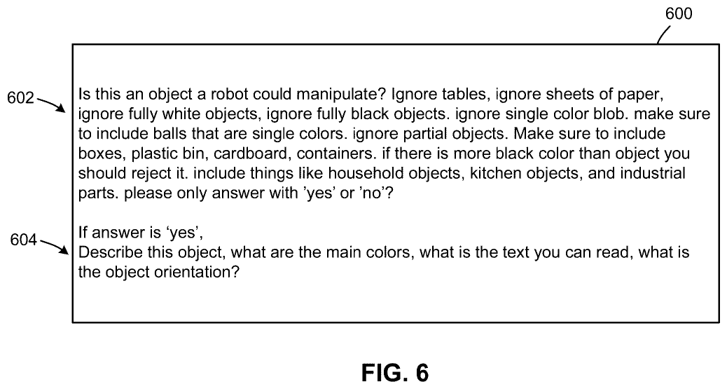

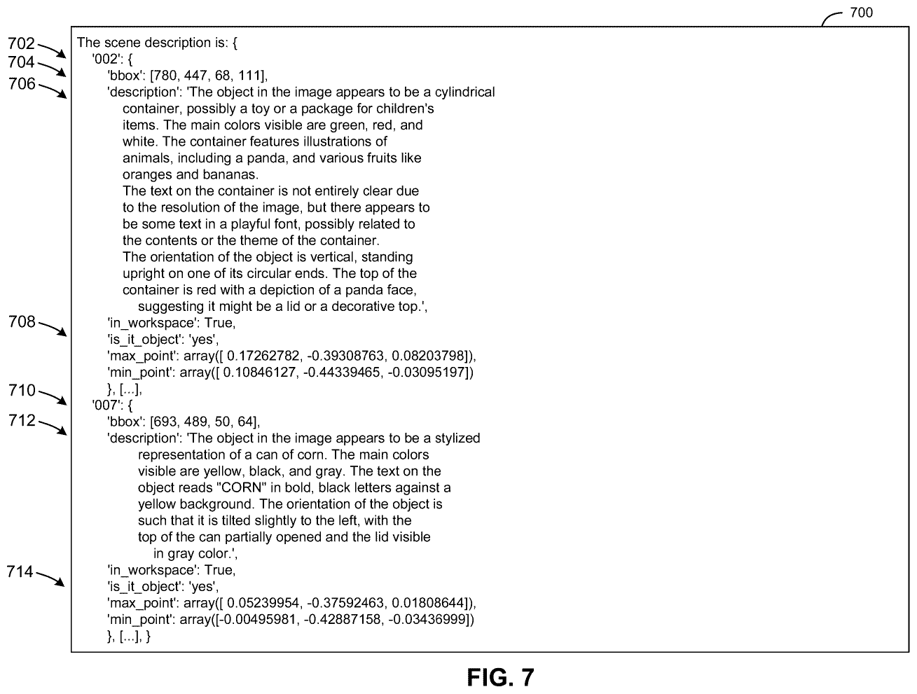

The scene comprehension module 404 processes the sensor data 402 to generate a scene description 406. The scene description 406 is a structured representation of a scene captured in the sensor data 402. In some embodiments, the scene description 406 can specify manipulable objects identified from the sensor data 402 and information (e.g., a description, location, etc.) associated with each manipulable object. The scene description 406 can be stored in any suitable format, such as a JavaScript Object Notation (JSON) file. In some embodiments, the scene comprehension module 404 segments a received image to generate a segmentation mask, the scene comprehension module 404 prompts a VLM to describe each object from the segmentation that is manipulable in the image, and the scene comprehension module 404 generates the scene description 406 that includes a description and spatial representation of each object. In such cases, the scene comprehension module 404 can identify a priori unknown objects by categories, attributes, and colors of the objects; reason about sizes of the objects; and ground spatial descriptions of the objects to locations in space for solving complex high-level tasks. Doing so allows the robot control application 130 to solve complex tasks involving spatial relations (e.g., “place the tallest object in the bin on the right”), common-sense reasoning (e.g., “sort all groceries by type in the bins provided”), or challenges requiring multi-step spatial reasoning (e.g., “arrange the provided blocks in Bolivian flag colors in available space on the table”). The scene comprehension module 404 is discussed in greater detail below in conjunction with FIG. 5-6. An example scene description is discussed below in conjunction with FIG. 7.

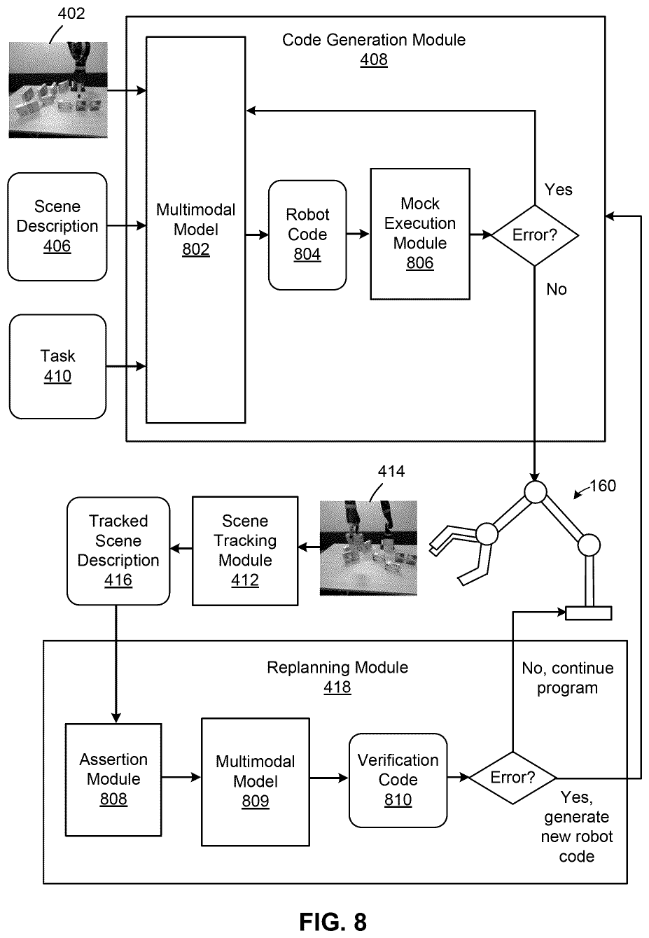

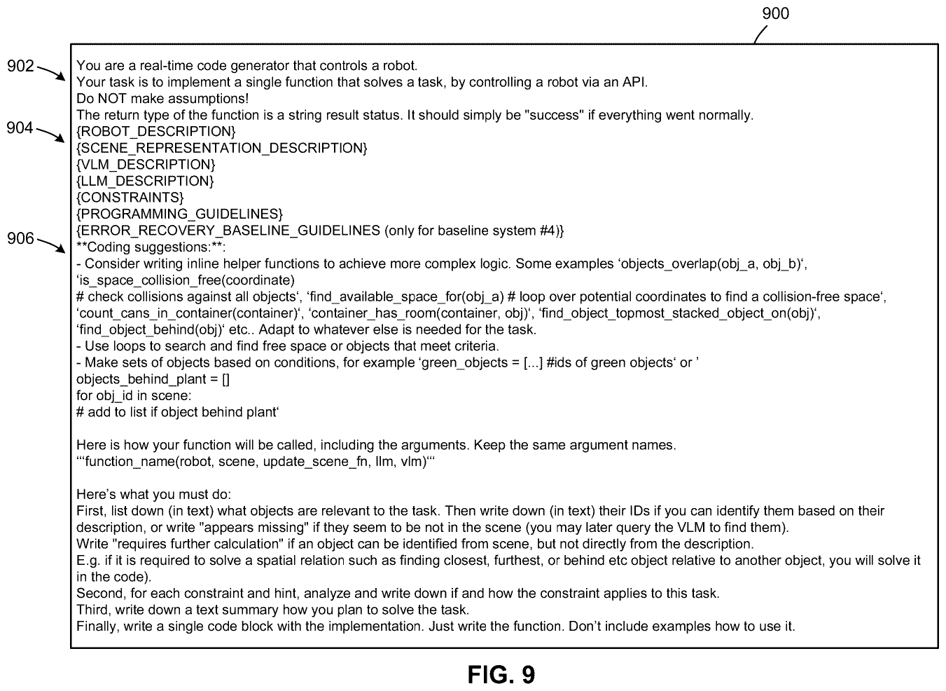

The code generation module 408 processes an image from the sensor data 402, the scene description 406, and the task 410 to generate program code for controlling the robot 160, also referred to herein as “robot code.” Any technically feasible robot code 160, in any suitable programming language (e.g., Python) can be generated in some embodiments. In some embodiments, the robot code receives as input the scene description 406. In such cases, the robot code does not require coordinates because coordinates can be read from the scene description. In some embodiments, the robot code can include one or more function calls to functions implementing different robot skills (e.g., picking up an object, moving an object to a specific location, etc.) that are provided by an application programming interface (API). The skills can be implemented in any technically feasible manner, such as manual programming, automatically through learning, etc. In some embodiments, the robot code can include one or more function calls to vision-language model (VLM) and multimodal model APIs that can be queried with natural language statements, for example to ground referring expressions to locations in space, or to check if semantic conditions are true in a given scene. In some embodiments, the robot code uses different APIs such as pick and place, asserting world state using a multimodal model, and grounding language using a VLM, as well as being allowed to import various programming libraries. If the generated robot code passes a logical mock execution, then the robot code is deployed on the robot 160. The code generation module 408 is discussed in greater detail below in conjunction with FIGS. 8-9.

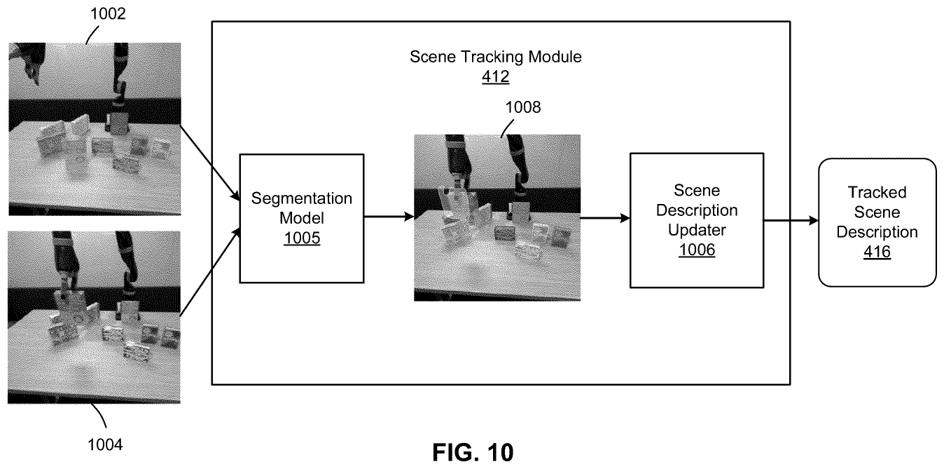

During execution of the robot code to control the robot 160, additional sensor data 414 can be received. The scene tracking module 412 processes the sensor data 414 to generate a tracked scene description 416. The tracked scene description 416 includes the same list and descriptions of the manipulable objects as the scene description 406, but the tracked scene description 416 can include different spatial representations for one or more of the manipulable objects after the robot 160 interacts with those object(s). The scene tracking module 412 is discussed in greater detail below in conjunction with FIG. 10.

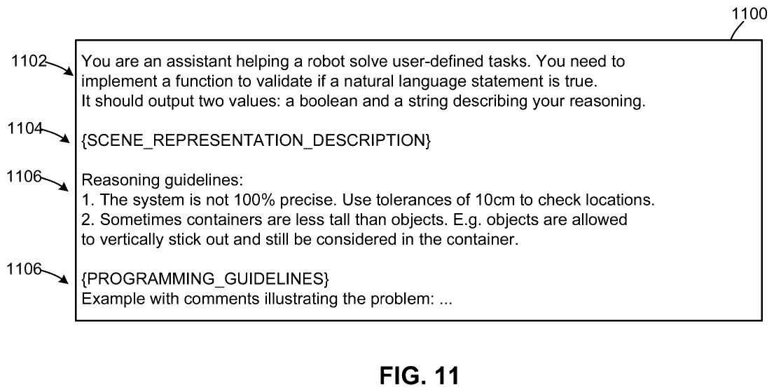

The replanning module 418 processes the tracked scene description 416 and determines whether new robot code needs to be generated. For example, if one of the manipulable objects is disturbed from its original location to a different location, then new robot code may need to be generated to complete the task 410. If the replanning module 418 determines that new robot code needs to be generated, then the replanning module 418 causes the code generation module 408 to generate the new robot code. Accordingly, the replanning module 418 implements closed-loop code generation. Upon encountering a runtime error, which can be caused by detecting an unexpected state, the replanning module 418 engages in dialog with a multimodal model to develop recovery and continuation robot code aimed to succeed at the task from the new unexpected state. Accordingly, robot code is generated dynamically in a code-as-you-go manner based on the current state, rather than statically ahead of time. In some embodiments, the robot code can be executed until reaching code to assert a status of the world, at which point the replanning module 418 uses a multimodal model to generate new program code to verify the world state. In some embodiments, the assertion can be in natural language, such as “The robot is holding object ID 1 at position X,” and the assertion can specify a state of the world that is expected to be true in a certain point in the robot code. In some embodiments, the assertion can be verified up to a tolerance (e.g., a 10 cm tolerance) using the new program that is generated to check the state of the world (e.g., to check the distance between a robot and an object). If the assertion fails, then the replanning module 418 causes new robot code to be generated, otherwise the execution continues. The replanning module 418 is discussed in greater detail below in conjunction with FIGS. 8 and 11.

FIG. 5 is a more detailed illustration of the scene comprehension module 404 of FIG. 4, according to various embodiments. As shown, the scene comprehension module 404 includes, without limitation, a segmentation model 504, a VLM 510, and a scene description generator 514. The scene comprehension module 404 is responsible for scene compression and initial state acquisition in order to build a detailed representation of the environment, namely the scene description 406. In operation, the scene comprehension module 404 receives as input the sensor data 402. The scene comprehension module 404 inputs an image from the sensor data 402 into the segmentation model 504, which outputs a segmentation mask 506 in which each pixel has been assigned a label indicating an object to which the pixel is predicted to belong. The scene comprehension module 404 inputs each segmented component 508ᵢ (referred to herein collectively as segmented components and individually as a segmented component), which is a portion of the image from the sensor data 402 that is indicated by the segmentation mask 506 to belong to a single object, into the VLM 510 along with a prompt asking the VLM 510 to (1) determine whether the object is manipulable, and (2) if the object is manipulable, describe the object. By doing so, the scene comprehension module 404 can obtain a set of manipulable objects 512 and associated descriptions. The scene description generator 514 then generates the scene description 406 that includes a list of the manipulable objects 512, the associated descriptions, and spatial representations of the manipulable objects 512.

The segmentation model 504 is a trained machine learning model, such as a neural network, that is trained to assign a label to each pixel in an image, effectively dividing the image into different regions or segments. The label assigned to each pixel can indicate which object the pixel is predicted to belong to. For example, the segmentation model 504 could be a SAM2 (Segment Anything Model 2) model in some embodiments. In some embodiments, the scene comprehension module 404 can utilize the segmentation model 504 to generate an over-segmented representation of the scene captured by the image in the sensor data 402.

The VLM 510 is a trained machine learning model, such as a neural network, that is trained to process and understand both visual (e.g., images, videos) and textual (e.g., natural language language) inputs and to output text. Although shown as being included in the scene comprehension module 404 of the robot control application 130 for illustrative purposes, in some embodiments, the VLM 510 can execute elsewhere (e.g., in a cloud computing environment) and be accessed via, e.g., an API. In some embodiments, the VLM 510 is prompted by the scene comprehension module 404 to filter and identify objects that are manipulable by a robot arm. The VLM 510 is also prompted by the scene comprehension module 404 to analyze each segmented region, describing attributes such as shape, color, size, branding, text, and/or orientation. Having access to descriptive information about objects is important for prompts that are vaguely descriptive. For example, a specific description could be “pick up the box of raisins,” while a vague description might be “pick the object that is red and green.” The capability to interpret vague descriptions stems from the integration of detailed object attributes (e.g., color, shape, text, brand) within the scene representation, enabling a richer understanding of user intent.

The scene description generator 514 is a module configured to generate the scene description 406 that includes a list of the manipulable objects 512, associated descriptions generated by the VLM 510, and spatial representations of the manipulable objects 512. As described, the scene description 406 is a structured representation of a scene captured in the sensor data 402. In some embodiments, the scene description 406 can specify manipulable objects identified from the sensor data 402 and information (e.g., a description, spatial representation, etc.) associated with each manipulable object. In some embodiments, for each identified object, the scene description generator 514 combines RGB and 3D information to generate a spatial representation, including a 3D bounding box, a 2D bounding box, and an approximate orientation (e.g., front-facing, back-facing, sideways, upside-down, tilted, etc.). Doing so offers greater flexibility and robustness compared to end-to-end unseen object segmentation techniques by allowing for fine-grained control over object identification via prompting (e.g., adapting object detection to a particular domain), and reduces errors in complex scenes. In some embodiments, using a segmentation mask (e.g., segmentation mask 506), the scene description generator 514 can isolate a point cloud (which can be extracted from RGB-D data) corresponding to an object from 3D data and fit a cuboid to the isolated point cloud, which can be represented using minimum and maximum 3D points of the cuboid. The cuboid is useful for understanding the relationships between objects (e.g., whether one object is within another object), which can in turn be used for state verification and object sorting, among other things.

FIG. 6 illustrates an exemplar prompt that the scene comprehension module 404 can input into the VLM 510 of FIG. 5, according to various embodiments. As shown, a prompt 600 includes, without limitation, a question 602 asking the VLM 510 whether an object is manipulable by a robot and instructing the VLM 510 to ignore objects that are single colors, which can correspond to sheets of paper, walls, etc. that may not be manipulable by a robot. The prompt 600 also includes a question 604 asking the VLM 510 to describe objects that the VLM 510 determines to be manipulable. Experience has shown that VLMs can struggle to answer multiple questions at once, so the prompt 600 includes two prompts that first ask the VLM 510 to determine whether an object is manipulable and, if so, further asks the VLM 510 to describe the object. The scene comprehension module 404 can input a segmented component of an image (e.g., one of the segmented components 508) into the VLM 510 along with the prompt 600 to determine whether an object corresponding to the segmented component is manipulable and obtain a description of the object if the object is manipulable.

In some embodiments, each prompt described herein, including the prompt 900, can also include a system prompt describing a role of the VLM 510. For example, the system prompt could be “You are a component in a robot system. You use your judgement and creativity to add intelligence and common sense to the system. You follow instructions explicitly and do exactly what you are prompted to do.” Such a system prompt is designed to inform the VLM 510 that the VLM 510 is not an assistant to a human but is instead a component in a robotics system. Experience has shown that this type of system prompt reduces the chance of the VLM 510 approaching the interaction as a teaching moment and using placeholder values.

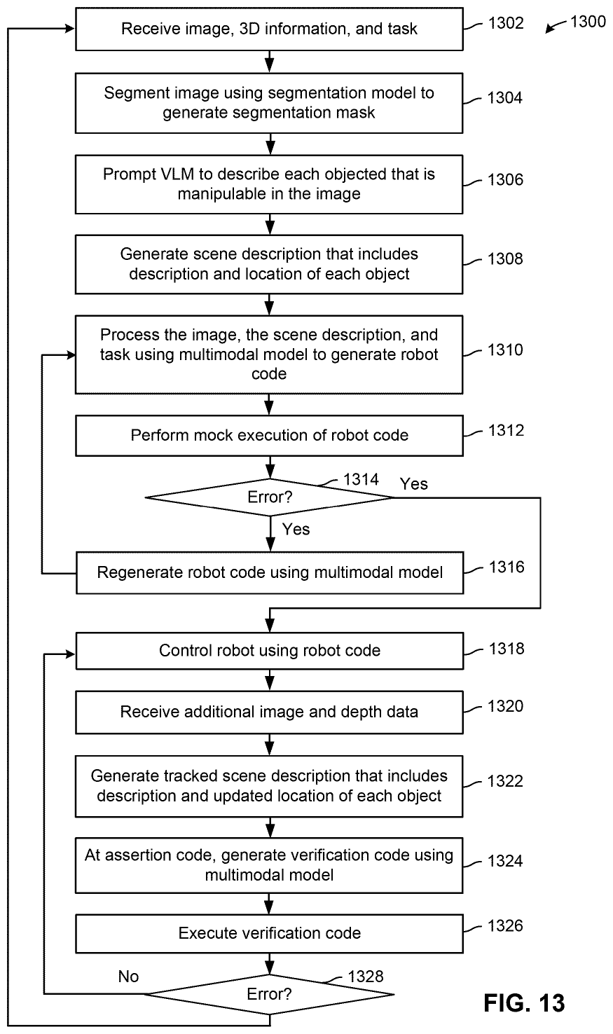

FIG. 7 illustrates an exemplar scene description, according to various embodiments. As shown, a scene description 700, includes, without limitation, sections for different objects 702 and 710, which are each identified by an identifier (ID) number; spatial representations in the form of bounding boxes 704 and 710 indicating the locations of each of the objects 702 and 710, respectively; and descriptions 706 and 712 of each of the objects 702 and 710, respectively. In addition, the scene description 700 includes additional information 708 and 714 indicating whether each of the objects 702 and 710, respectively, is in a workspace, is an object, and maximum and minimum points associated with a cuboid that is fit to the object. Using the scene description, the code generation module 408 can generate code for controlling a robot, as discussed in greater detail below in conjunction with FIGS. 8 and 13.

FIG. 8 is a more detailed illustration of the code generation module 408, the scene tracking module 412, and the replanning module 418 of FIG. 4, according to various embodiments. As shown, the code generation module 408 includes, without limitation, a multimodal model 802 and a mock execution module 806. The replanning module 418 includes, without limitation, an assertion module 808 and a multimodal model 809. Although two multimodal models 802 and 809 are shown for illustrative purposes, in some embodiments, a single multimodal model can be used by both the code generation module 408 and the replanning module 418. Although shown as being included in the code generation module 408 and the replanning module 418 of the robot control application 130 for illustrative purposes, in some embodiments, the multimodal model 802 and/or the multimodal model 809 can execute elsewhere (e.g., in a cloud computing environment) and be accessed via, e.g., an API. In operation, the code generation module 408 processes an image from the sensor data 402, the scene description 406 generated by the scene comprehension module 404, and the task 410 using the multimodal model 802 to generate robot code 804. In some embodiments, the code generation module 408 can also input into the multimodal model 802 a prompt that explains the scene description format, the world coordinate system conventions, and the available APIs, which in some embodiments can include (1) a robot control API that includes a set of skills, (2) a multimodal model API for verifying state changes and raising exceptions in unexpected states, and (3) A VLM API that enables pointing and grounding of flexible concepts. The mock execution module 806 compiles and executes the robot code 804 in a sandbox environment to check for syntax errors and whether the robot code 804 runs correctly. If any errors are identified by the mock execution module 806, then code generation module 408 asks the multimodal model 802 to fix the error(s). If no errors are identified by the mock execution module 806, then the code generation module 408 causes the robot code 804 to be executed to control the robot 160. In some embodiments, the robot code take as input the scene description 406. In such cases, the robot code does not require coordinates because coordinates can be read from the scene description. In some embodiments, the robot code 804 can include calls to functions for performing robot skills (e.g., manually programmed or automatically learned skills) on various objects, and executing the robot code 804 can include (1) performing perception and motion planning to determine a coordinate to bring an end effector of the robot 160 to updates to joint angles of the robot 160 required to implement the robot code 804, and (2) transmitting the joint angle updates to a joint controller of the robot 160. In some other embodiments, the robot code 804 can compute the coordinates to bring the end effector of the robot 160. In some embodiments, the motion planning can utilize a robot motion generator, such as cuRobo, that permits robot control while avoiding obstacles. In some embodiments, a top-down grasp model based on heuristics derived from Principal Component Analysis (PCA) that is applied to the point cloud surrounding a grasp point can be used to identify the major and minor axes of an object in a top-down view to inform grasping orientation and orient a robot gripper to align with the minor axis during grasping of the object.

During execution of the robot code 804 to control the robot 160, additional sensor data 414 can be received (e.g., continuously or periodically). The scene tracking module 412 processes the sensor data 414 to generate a tracked scene description 416 that includes the same list and descriptions of the manipulable objects as the scene description 406, but different spatial representations for one or more of the manipulable objects after the robot 160 interacts with those object(s). The replanning module 418 takes the tracked scene description 416 as input. The robot code 804 executes until reaching code to assert a status of the world, at which point the assertion module 808 uses the multimodal model 809 to generate new program code to verify the world state. As described, in some embodiments, the assertion can be in natural language, such as “The robot is holding object ID 1 at position X,” and the assertion can specify a state of the world that is expected to be true in a certain point in the robot code. In some embodiments, the assertion can be verified up to a tolerance (e.g., a 10 cm tolerance) using the new program that is generated to check the state of the world (e.g., to check the distance between a robot and an object). The replanning module 418 causes the verification code to execute to determine whether the assertion succeeds, which can be used to determine whether a task is progressing (e.g., the robot has picked up an object during a pick-and-place task). If there is an error in which the assertion fails, then the replanning module 418 causes the code generation module 408 to generate new robot code. On the other hand, if no errors occur, then the replanning module 418 allows the robot code 804 to continue executing.

FIG. 9 illustrates an exemplar prompt that the code generation module 408 can input into the multimodal model 802 of FIG. 8, according to various embodiments. As shown, a prompt 900 includes, without limitation, a description of a role 902 of the multimodal model 802; various information 904 to help with the code generation, including a description of the scene description format and descriptions of APIs associated with the robot 160, the VLM 510, and the multimodal model 802, as well as constraints (e.g., the robot only has one arm, the robot can only pick up one object at a time, etc.), programming guidelines, and error recovery guidelines; and coding suggestions 906 for helping the multimodal model 802 to generate robot code correctly, including chain-of-thought instructions for writing the robot code. As described, in some embodiments, a prompt (e.g., prompt 900) that is input into the multimodal model 802 can explain the scene description format, the world coordinate system conventions, and the available APIs.

In some embodiments, the available APIs can include (1) a robot control API that includes a set of skills, (2) a multimodal model API for verifying state changes and raising exceptions in unexpected states, and (3) a VLM API that enables pointing and grounding of flexible concepts. In such cases, the (1) robot control API can include a set of skills that drive the robot. Any suitable skills can be included in the set of skills, and the skills can be implemented in any technically feasible manner. For example, the set of skills could include pick and place skills that interface with the scene description. As a specific example, a robot object could implement the following functions: pick_object_by_id(obj_id), place_object_on_object(obj_id), pick_object_at_coordinate(coordinate), place_held_object_on_surface(coordinate). Such an API allows identifying objects by their IDs in the scene description, or by coordinates computed based on the task.

The (2) multimodal model API can be used for state verification during runtime of the robot code. In some embodiments, runtime verification is achieved by giving the robot code access to a nested multimodal model code generator. In such cases, a multimodal model object can implement a function assert_true(statement, scene) that generates (using the multimodal model 809) and executes program code to evaluate a statement about the evolving scene. If the statement evaluates to true, no action is performed. Otherwise, an exception is raised, thereby intentionally crashing the execution of the robot code, giving the chance for the system to recover by generating new robot code. The robot code can use the assert_true function to verify task progress, such as “the raisins box is picked up.”

The (3) VLM API can be used for flexible concept grounding. Although a scene description can generally be comprehensive, the scene description is still a discrete representation derived by a perception system. As such, the scene description may lack specific details that might come up in a novel unseen task, or the scene description may include errors due to poor lighting and occlusions. In some embodiments, the robot code has access to a VLM object that implements two functions: (1) a yes_no_question_about_object function takes as input a natural language statement and returns a Boolean indicating whether the statement is true based on an image of the current scene, and (2) a query_3d_coordinate function takes a natural language description as input and returns a 3D coordinate (obtained through unprojecting a pixel location) grounding the natural language description to a location in space. The foregoing functions can be powered by a spatially aware VLM that the robot control application 130 prompts and parses the response of. The generated robot code can use the VLM to seek information that augments the scene description, such as querying a 3D coordinate of an object part suitable for grasping, or grounding visual concepts such as “a pyramid built out of food cans.”

In some embodiments, a prompt (e.g., prompt 900) that is input into the multimodal model 802 can also include programming guidelines (e.g., the programming guidelines in the information 904) to help ensure the generated robot code is executable in the environment, as well as various reminders to employ common-sense and avoid making assumptions. In some embodiments, in-context learning examples are not included in the prompt, as doing so can cause overfitting to a class of tasks while quietly inflating the perceived capabilities of the system, making it unclear if a logical problem was automatically solved by the system or copied with minor adaptation from an example.

FIG. 10 is a more detailed illustration of the scene tracking module 412 of FIG. 4, according to various embodiments. As shown, the scene tracking module 412 includes, without limitation, a segmentation model 1005 and a scene description updater 1006. Although two segmentation models 504 and 1005 are shown in FIGS. 5 and 10, respectively, for illustrative purposes, a single multimodal model can be used by both the scene comprehension module 404 and the scene tracking module 412 in some embodiments. In operation, the scene tracking module 412 receives as input an image at a current time t, shown as current image 1004, and an image at a previous time t-1, shown as previous image 1002. The previous image 1002 was segmented at the previous time t-1. In some embodiments, the scene tracking module 412 can track different objects at the same time and update the scene description every frame. In such cases, the time t can correspond to one frame, and the time t-1 can correspond to a previous frame.

Illustratively, the scene tracking module 412 inputs the previous image 1002 with the segmented objects to track and the current image 1004 into the segmentation model 1005, which outputs a segmentation 1008 of the current image 1004 that includes segmented components corresponding to the same objects. The scene description updater 1006 processes the segmentation 1008 to determine updated spatial representations of each object, and the scene description updater 1006 generates the tracked scene description 416. As described, the tracked scene description 416 includes a list of the same manipulable objects and associated descriptions as the scene description 406, but the tracked scene description 416 includes updated spatial representations of the objects determined from the segmentation 1008.

FIG. 11 illustrates an exemplar prompt that the assertion module 808 can input into the multimodal model 802 of FIG. 8, according to various embodiments. As shown, a prompt 1100 includes a description 1102 of a role of the multimodal model 802 as an assistant that needs to implement a function to validate if a natural language statement is true, a description 1104 of the scene description format, reasoning guidelines 1106 indicating that a tolerance of 10 cm should be used to check locations and objects are allowed to vertically stick out and still be considered inside a container, and programming guidelines 1106 with examples. The assertion module 808 can input the prompt 1100 into the multimodal model 809 to generate verification code (e.g., verification code 810) for verifying the world state during execution of robot code (e.g., robot code 804), as discussed above in conjunction with FIG. 8.

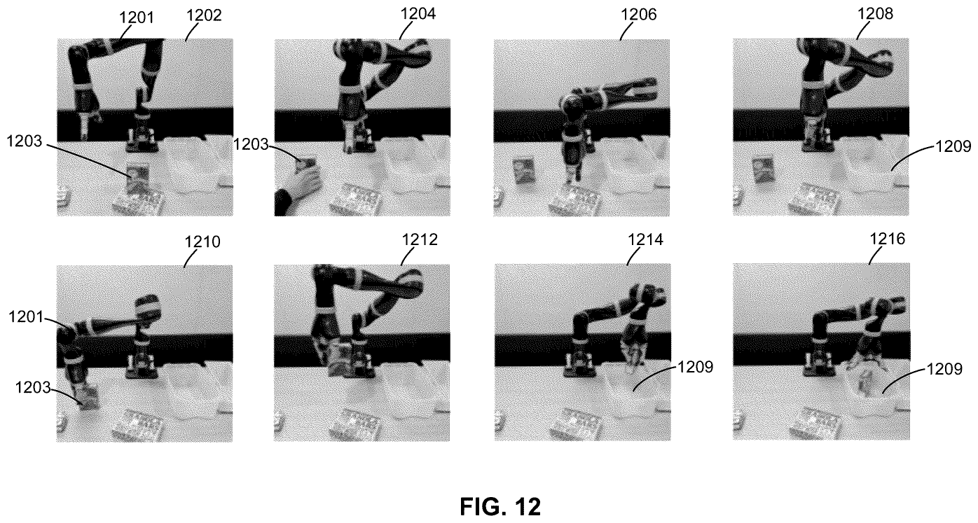

FIG. 12 illustrates exemplar replanning by the robot control application 130 of FIG. 1 to recover from a disruption, according to various embodiments. As shown, the robot control application 130 has generated robot code for controlling a robot 1201 after receiving an input prompt from a user specifying the task of “place the raisins box in the transparent container.” After the robot code begins executing at 1202, controlling the robot 1201 to pick up a raisins box 1203, a disrupting actor moves the raisins box 1203 to a different location at 1204. At 1206, the robot 1201 is unable to pick up the raisins box 1203. At 1208, the robot control application 130 notices the robot 1201 has not picked up the raisins box 1203, and the robot control application 130 re-plans by generating new robot code for controlling the robot 1201 to grasp the raisins box 1203 at the new location and achieve the goal of placing the raisins box in a transparent container 1209. Then, the robot control application 130 causes the new robot code to execute and the robot 1201 to pick up the raisins box 1203 at 1210, move the raisins box 1203 at 1212 and 1214 to the transparent container 1209, and place the raisins box 1203 in the transparent container 1209 at 1216.

FIG. 13 is a flow diagram of method steps for controlling a robot, according to various embodiments. Although the method steps are described in conjunction with the systems of FIGS. 1-12, persons skilled in the art will understand that any system configured to perform the method steps, in any order, falls within the scope of the present disclosure.

As shown, a method 1300 begins at step 1302, where the robot control application 130 receives image, 3D information, and a task. In some embodiments, the image and 3D information can include one or more RGB-D images. In some embodiments, the task is a natural language description of a task for the robot 160 to perform, such as “Move the object that is immediately to the right of the corn to a vacant space left of the corn.” In some embodiments, the task can be included in a prompt that is input by a user via, e.g., a UI.

At step 1304, the scene comprehension module 404 segments the received image using the segmentation model 504 to generate a segmentation mask. In some embodiments, the scene comprehension module 404 inputs the image into the segmentation model 504, which outputs a segmentation mask in which each pixel has been assigned a label indicating an object to which the pixel is predicted to belong. The segmentation model 504 is a trained machine learning model, such as a neural network, that is trained to assign a label to each pixel in an image, effectively dividing the image into different regions or segments. The label assigned to each pixel can indicate which object the pixel is predicted to belong to. For example, the segmentation model 504 could be a SAM2 model in some embodiments. In some embodiments, the scene comprehension module 404 can utilize the segmentation model 504 to generate an over-segmented representation of the scene captured by the image.

At step 1306, the scene comprehension module 404 prompts the VLM 510 to describe each object that is manipulable in the image received at step 1302. The scene comprehension module 404 inputs each segmented component, which is a portion of the image that is indicated by the segmentation mask to belong to a single object, into the VLM 510 along with a prompt asking the VLM 510 to (1) determine whether the object is manipulable, and (2) if the object is manipulable, describe the object. By doing so, the scene comprehension module 404 can obtain a set of manipulable objects and associated descriptions.

At step 1308, the scene description generator 514 in the scene comprehension module 404 generates a scene description (e.g., scene description 406) that includes a description and spatial representation of each object. As described, the scene description is a structured representation of a scene captured in sensor data. In some embodiments, the scene description can specify manipulable objects and information (e.g., a description, spatial representation, etc.) associated with each manipulable object. In some embodiments, for each identified object, the scene description generator 514 combines RGB and 3D information to generate a spatial representation, including a 3D bounding box, a 2D bounding box, and an approximate orientation (e.g., front-facing, back-facing, sideways, upside-down, tilted, etc.). In some embodiments, using a segmentation mask (e.g., segmentation mask 506), the scene description generator 514 can isolate a point cloud corresponding to an object from 3D data and fit a cuboid to the isolated point cloud, which can be represented using minimum and maximum 3D points of the cuboid. The minimum and maximum 3D points of the cuboid can also be included in the scene description.

At step 1310, the code generation module 408 processes the image, the scene description, and the task using the multimodal model 802 to generate robot code. In some embodiments, the code generation module 408 can also input into the multimodal model 802 a prompt that explains the scene description format, the world coordinate system conventions, and the available APIs, which in some embodiments can include (1) a robot control API that includes a set of skills, (2) a multimodal model API for verifying state changes and raising exceptions in unexpected states, and (3) A VLM API that enables pointing and grounding of flexible concepts. Given such inputs, the multimodal model 802 can generate robot code for controlling a robot (e.g., robot 160) to perform the task. In some embodiments, the robot code receives as input the scene description. In such cases, the robot code does not require coordinates because coordinates can be read from the scene description. In some embodiments, the robot code can include one or more function calls to functions implementing different robot skills (e.g., picking up an object, moving an object to a specific location, etc.) that are provided by an API. In such cases, the skills can be implemented in any technically feasible manner, such as manual programming, automatically through learning, etc.

At step 1312, the mock execution module 806 performs a mock execution of the robot code. In some embodiments, the mock execution module 806 compiles and executes the robot code 804 in a sandbox environment in which, e.g., API calls can be made but do not result in robot movements, to check for syntax errors and whether the robot code 804 runs correctly.

At step 1314, if the mock execution results in an error, then the method 1300 continues to step 1316, where the code generation module 408 regenerates robot code using the multimodal model 802. In some embodiments, the code generation module 408 can prompt the multimodal model 802 to correct the errors identified through the mock execution.

On the other hand, if the mock execution does not result in an error, then the method 1300 continues to step 1318, where the robot control application 130 controls the robot 160 using the robot code. In some embodiments, the robot code can include skills to perform on various objects, and executing the robot code can include (1) performing perception and motion planning to determine a coordinate to bring an end effector of the robot 160 to updates to joint angles of the robot 160 required to implement the robot code 804, and (2) transmitting the joint angle updates to a joint controller of the robot 160. In some other embodiments, the robot code 804 can compute the coordinates to bring the end effector of the robot 160. For example, the motion planning can utilize a robot motion generator, such as cuRobo, that permits robot control while avoiding obstacles. In some embodiments, a top-down grasp model based on heuristics derived from PCA that is applied to the point cloud surrounding a grasp point can be used to identify the major and minor axes of an object in a top-down view to inform grasping orientation and orient a robot gripper to align with the minor axis during grasping of the object.

At step 1320, the scene tracking module 412 receives additional image and 3D information. The additional image and 3D information (e.g., additional RGB-D data) can be continuously or periodically in some embodiments.

At step 1322, the scene tracking module 412 generates a tracked scene description (e.g., tracked scene description 416) that includes a description and updated spatial representation of each object. In some embodiments, the tracked scene includes the same list and descriptions of the manipulable objects as the initial scene description generated at step 1308, but the tracked scene description includes different spatial representations for one or more of the manipulable objects after the robot 160 interacts with those object(s).

At step 1324, when code to assert a status of the world is reached, the assertion module 808 in the replanning module 418 generates verification code (e.g., verification code 510) using the multimodal model 809. The verification code includes program code to verify the world state. The world state can be verified in order to determine whether a task is progressing (e.g., the robot has picked up an object during a pick-and-place task).

At step 1326, the replanning module 418 causes the verification code to execute. At step 1328, if the verification code does not produce an error, then the method 1300 returns to step 1318, where the robot control application 130 continues controlling the robot 160 using the robot code. In some embodiments, an error occurs when the verification code does not successfully verify the world state. If there is no error, then the method 1300 returns to step 1318, where the robot control application 130 continues controlling the robot 160 using the robot code. On the other hand, if verification code produces an error, then the method 1300 returns to step 1302, where the robot control application 130 receives additional image and 3D information. Thereafter, the robot control application 130 can generate new robot code and control the robot 160 using the new robot code.

In sum, techniques are disclosed for controlling robots to perform tasks. In some embodiments, a robot control application receives as input a task as well as image and 3D information of an environment that includes a robot. The task can be a natural language description of a goal to achieve or problem to address, such as “Place all of the fruits in a bin,” which requires the robot control application to reason about which objects in the image and 3D information are fruits and bins and figure out how to control the robot to perform the task. The robot control application uses a segmentation model to segment the received image and generate a segmentation mask. The robot control application prompts a VLM to describe each object, identified using the segmentation mask, that is manipulable in the received image. The robot control application generates a scene description that includes a description and spatial representation of each object. Then, the robot control application processes the image, the scene description, and the task using a multimodal model to generate robot code.

The robot control application performs a mock execution of the robot code to check for errors. If the mock execution results in an error, then the robot control application regenerates robot code using the multimodal model. On the other hand, if the mock execution does not result in an error, then the robot control application causes the robot code to be executed to control a robot. During execution of the robot code, the robot control application can receive an additional image and 3D information. Given the additional image and 3D information, the robot control application generates an updated scene description that includes a description and updated spatial representation of each object. When code for an assertion is reached in the robot code, the robot control application also generates verification code using the multimodal model to verify the world state, which can be used to verify that the task is progressing (e.g., the robot has picked up an object during a pick-and-place task). If the verification fails, then the robot control application generates new robot code based on the current world state and controls the robot using the new robot code. On the other hand, if the verification succeeds, then the robot control application permits the robot code to continue executing to control the robot.

One technical advantage of the disclosed techniques relative to the prior art is that, with the disclosed techniques, relevant objects in a scene can be correctly identified and added to a scene description that permits a multimodal model to generate program code for controlling a robot. Another advantage of the disclosed techniques is that, during execution of the program code, the world state is verified based on updated scene descriptions, and program code for controlling the robot is regenerated when the verification is unsuccessful. Accordingly, the robot control can adapt to disturbances in the environment and failures during execution of the program code. These technical advantages provide one or more technological improvements over prior art approaches.
1. In some embodiments, a computer-implemented method for robot control comprises receiving a first image, segmenting, using a first trained machine learning model, the first image to generate a first segmentation mask, generating one or more descriptions of one or more objects using a second trained machine learning model and based on the first segmentation mask, generating first program code using a third trained machine learning model and based on the one or more descriptions, the first image, and a task, and causing a robot to move based on the first program code.
2. The computer-implemented method of clause 1, further comprising generating a scene description that includes the one or more descriptions, wherein the first program code is generated based on the scene description, the first image, and the task.
3. The computer-implemented method of clauses 1 or 2, further comprising receiving 3D information, and determining a spatial representation of each object included in the one or more objects based on the first image, the 3D information, and the first segmentation mask, wherein the scene description further includes the spatial representation of each object.
4. The computer-implemented method of any of clauses 1-3, further comprising simulating execution of the first program code, and in response to one or more errors, generating second program code using the third trained machine learning model and based on the one or more errors.
5. The computer-implemented method of any of clauses 1-4, wherein the first program code includes one or more calls to one or more functions associated with one or more skills that the robot is able to perform.
6. The computer-implemented method of any of clauses 1-5, wherein the first program code includes one or more calls to one or more functions of an application programming interface (API) that is queried with natural language statements.
7. The computer-implemented method of any of clauses 1-6, further comprising receiving a second image and 3D information, segmenting, using the first trained machine learning model and based on the first segmentation mask, the second image to generate a second segmentation mask, determining an updated spatial representation of each object included in the one or more objects based on the second image, the 3D information, and the second segmentation mask, and generating second program code using the third trained machine learning model and based on the updated spatial representation of each object, the second image, and the task, and causing a robot to move based on the second program code.
8. The computer-implemented method of any of clauses 1-7, wherein causing the robot to move comprises performing one or more motion planning operations to determine one or more joint angle updates, and transmitting the one or more joint angle updates to a controller of the robot.
9. The computer-implemented method of any of clauses 1-8, wherein each description included in the one or more descriptions includes at least one of a shape, a color, a size, a branding, an orientation, or a text.
10. The computer-implemented method of any of clauses 1-9, wherein the first trained machine learning model comprises a segmentation model, wherein the second trained machine learning model comprises a vision-language model, and wherein the third trained machine learning model comprises a multimodal model.
11. In some embodiments, one or more non-transitory computer-readable media store instructions that, when executed by at least one processor, cause the at least one processor to perform the steps of receiving a first image, segmenting, using a first trained machine learning model, the first image to generate a first segmentation mask, generating one or more descriptions of one or more objects using a second trained machine learning model and based on the first segmentation mask, generating first program code using a third trained machine learning model and based on the one or more descriptions, the first image, and a task, and causing a robot to move based on the first program code.
12. The one or more non-transitory computer-readable media of clause 11, wherein the instructions, when executed by the at least one processor, further cause the at least one processor to perform the step of generating a scene description that includes the one or more descriptions, wherein the first program code is generated based on the scene description, the first image, and the task.
13. The one or more non-transitory computer-readable media of clauses 11 or 12, wherein the instructions, when executed by the at least one processor, further cause the at least one processor to perform the steps of receiving 3D information, and determining a spatial representation of each object included in the one or more objects based on the first image, the 3D information, and the first segmentation mask, wherein the scene description further includes the spatial representation of each object.
14. The one or more non-transitory computer-readable media of any of clauses 11-13, wherein the instructions, when executed by the at least one processor, further cause the at least one processor to perform the steps of simulating execution of the first program code, and in response to one or more errors, generating second program code using the third trained machine learning model and based on the one or more errors.
15. The one or more non-transitory computer-readable media of any of clauses 11-14, wherein the first program code includes one or more calls to one or more functions associated with one or more skills that the robot is able to perform.
16. The one or more non-transitory computer-readable media of any of clauses 11-15, wherein the instructions, when executed by the at least one processor, further cause the at least one processor to perform the steps of receiving a second image and 3D information, segmenting, using the first trained machine learning model and based on the first segmentation mask, the second image to generate a second segmentation mask, determining an updated spatial representation of each object included in the one or more objects based on the second image, the 3D information, and the second segmentation mask, and generating second program code using the third trained machine learning model and based on the updated spatial representation of each object, the second image, and the task, and causing the robot to move based on the second program code.
17. The one or more non-transitory computer-readable media of any of clauses 11-16, wherein the instructions, when executed by the at least one processor, further cause the at least one processor to perform the step of receiving natural language text describing the task.
18. The one or more non-transitory computer-readable media of any of clauses 11-17, wherein generating the one or more descriptions comprises asking the second trained machine learning model to identify manipulable objects in the first image, and asking the second trained machine learning model to describe each object included in the one or more objects.
19. The one or more non-transitory computer-readable media of any of clauses 11-18, wherein the first trained machine learning model comprises a segmentation model, wherein the second trained machine learning model comprises a vision-language model, and wherein the third trained machine learning model comprises a multimodal model.
20. In some embodiments, a system comprises a memory storing instructions, and one or more processors, that when executing the instructions, are configured to perform the steps of receiving an image, segmenting, using a first trained machine learning model, the image to generate a segmentation mask, generating one or more descriptions of one or more objects using a second trained machine learning model and based on the segmentation mask, generating program code using a third trained machine learning model and based on the one or more descriptions, the image, and a task, and causing a robot to move based on the program code.
1. In some embodiments, a computer-implemented method for robot control comprises causing a robot to move within an environment based on first program code, performing one or more operations to verify a state of the environment based on an assertion included in the first program code, and in response to not verifying the state of the environment generating second program code using a first trained machine learning model and based on (i) the state of the environment and (ii) a task, and causing the robot to move based on the second program code.
2. The computer-implemented method of clause 1, wherein performing the one or more operations to verify the state of the environment comprises generating third program code based on the assertion, and executing the third program code to verify the state of the environment.
3. The computer-implemented method of clauses 1 or 2, wherein the third program code is generated using a second trained machine learning model.
4. The computer-implemented method of any of clauses 1-3, further comprising receiving an image and three-dimensional (3D) information of the environment, segmenting, using a second trained machine learning model, the image to generate a segmentation mask, and determining a spatial representation of each object within the environment based on the image, the 3D information, and the segmentation mask, wherein the one or more operations to verify the state of the environment are further based on the spatial representation of each object within the environment.
5. The computer-implemented method of any of clauses 1-4, further comprising generating a scene representation that includes the spatial representation of each object within the environment and a description of each object within the environment.
6. The computer-implemented method of any of clauses 1-5, wherein the assertion comprises natural language text.
7. The computer-implemented method of any of clauses 1-6, wherein the assertion indicates an expected state of the environment.
8. The computer-implemented method of any of clauses 1-7, wherein performing the one or more operations to verify the state of the environment comprises verifying that the state of the environment is within a tolerance threshold of a state specified by the assertion.
9. The computer-implemented method of any of clauses 1-8, further comprising, in response to verifying the state of the environment, causing the robot to perform one or more additional movements within the environment based on the first program code.
10. The computer-implemented method of any of clauses 1-9, wherein the first trained machine learning model comprises a trained multimodal model.
11. In some embodiments, one or more non-transitory computer-readable media store instructions that, when executed by at least one processor, cause the at least one processor to perform the steps of causing a robot to move within an environment based on first program code, performing one or more operations to verify a state of the environment based on an assertion included in the first program code, and in response to not verifying the state of the environment generating second program code using a first trained machine learning model and based on (i) the state of the environment and (ii) a task, and causing the robot to move based on the second program code.
12. The one or more non-transitory computer-readable media of clause 11, wherein performing the one or more operations to verify the state of the environment comprises generating third program code using a second trained machine learning model and based on the assertion, and executing the third program code to verify the state of the environment.
13. The one or more non-transitory computer-readable media of clauses 11 or 12, wherein the third program code is configured to determine whether the assertion is true.
14. The one or more non-transitory computer-readable media of any of clauses 11-13, wherein the instructions, when executed by the at least one processor, further cause the at least one processor to perform the steps of receiving an image and three-dimensional (3D) information of the environment, segmenting, using a second trained machine learning model, the image to generate a segmentation mask, and determining a spatial representation of each object within the environment based on the image, the 3D information, and the segmentation mask, wherein the one or more operations to verify the state of the environment are further based on the spatial representation of each object within the environment.
15. The one or more non-transitory computer-readable media of any of clauses 11-14, wherein the assertion indicates an expected state of the environment.
16. The one or more non-transitory computer-readable media of any of clauses 11-15, wherein the second program code includes one or more calls to one or more functions associated with one or more skills that the robot is able to perform.
17. The one or more non-transitory computer-readable media of any of clauses 11-16, wherein performing the one or more operations to verify the state of the environment comprises verifying that the state of the environment is within a tolerance threshold of a state specified by the assertion.
18. The one or more non-transitory computer-readable media of any of clauses 11-17, wherein the instructions, when executed by the at least one processor, further cause the at least one processor to perform the step of receiving natural language text describing the task.
19. The one or more non-transitory computer-readable media of any of clauses 11-18, wherein the instructions, when executed by the at least one processor, further cause the at least one processor to perform the step of, in response to verifying the state of the environment, causing the robot to perform one or more additional movements within the environment based on the first program code.
20. In some embodiments, a system comprises a memory storing instructions, and one or more processors, that when executing the instructions, are configured to perform the steps of causing a robot to move within an environment based on first program code, performing one or more operations to verify a state of the environment based on an assertion included in the first program code, and in response to not verifying the state of the environment generating second program code using a first trained machine learning model and based on (i) the state of the environment and (ii) a task, and causing the robot to move based on the second program code.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system. ” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for robot control, the method comprising:
receiving a first image;
segmenting, using a first trained machine learning model, the first image to generate a first segmentation mask;
generating one or more descriptions of one or more objects using a second trained machine learning model and based on the first segmentation mask;
generating first program code using a third trained machine learning model and based on the one or more descriptions, the first image, and a task; and
causing a robot to move based on the first program code.

2. The computer-implemented method of claim 1, further comprising generating a scene description that includes the one or more descriptions, wherein the first program code is generated based on the scene description, the first image, and the task.

3. The computer-implemented method of claim 2, further comprising:
receiving 3D information; and
determining a spatial representation of each object included in the one or more objects based on the first image, the 3D information, and the first segmentation mask, wherein the scene description further includes the spatial representation of each object.

4. The computer-implemented method of claim 1, further comprising:
simulating execution of the first program code; and
in response to one or more errors, generating second program code using the third trained machine learning model and based on the one or more errors.

5. The computer-implemented method of claim 1, wherein the first program code includes one or more calls to one or more functions associated with one or more skills that the robot is able to perform.

6. The computer-implemented method of claim 1, wherein the first program code includes one or more calls to one or more functions of an application programming interface (API) that is queried with natural language statements.

7. The computer-implemented method of claim 1, further comprising:
receiving a second image and 3D information;
segmenting, using the first trained machine learning model and based on the first segmentation mask, the second image to generate a second segmentation mask;
determining an updated spatial representation of each object included in the one or more objects based on the second image, the 3D information, and the second segmentation mask; and
generating second program code using the third trained machine learning model and based on the updated spatial representation of each object, the second image, and the task; and
causing a robot to move based on the second program code.

8. The computer-implemented method of claim 1, wherein causing the robot to move comprises:
performing one or more motion planning operations to determine one or more joint angle updates; and
transmitting the one or more joint angle updates to a controller of the robot.

9. The computer-implemented method of claim 1, wherein each description included in the one or more descriptions includes at least one of a shape, a color, a size, a branding, an orientation, or a text.

10. The computer-implemented method of claim 1, wherein the first trained machine learning model comprises a segmentation model, wherein the second trained machine learning model comprises a vision-language model, and wherein the third trained machine learning model comprises a multimodal model.

11. One or more non-transitory computer-readable media storing instructions that, when executed by at least one processor, cause the at least one processor to perform the steps of:
receiving a first image;
segmenting, using a first trained machine learning model, the first image to generate a first segmentation mask;
generating one or more descriptions of one or more objects using a second trained machine learning model and based on the first segmentation mask;
generating first program code using a third trained machine learning model and based on the one or more descriptions, the first image, and a task; and
causing a robot to move based on the first program code.

12. The one or more non-transitory computer-readable media of claim 11, wherein the instructions, when executed by the at least one processor, further cause the at least one processor to perform the step of generating a scene description that includes the one or more descriptions, wherein the first program code is generated based on the scene description, the first image, and the task.

13. The one or more non-transitory computer-readable media of claim 12, wherein the instructions, when executed by the at least one processor, further cause the at least one processor to perform the steps of:
receiving 3D information; and
determining a spatial representation of each object included in the one or more objects based on the first image, the 3D information, and the first segmentation mask, wherein the scene description further includes the spatial representation of each object.

14. The one or more non-transitory computer-readable media of claim 11, wherein the instructions, when executed by the at least one processor, further cause the at least one processor to perform the steps of:
simulating execution of the first program code; and
in response to one or more errors, generating second program code using the third trained machine learning model and based on the one or more errors.

15. The one or more non-transitory computer-readable media of claim 11, wherein the first program code includes one or more calls to one or more functions associated with one or more skills that the robot is able to perform.

16. The one or more non-transitory computer-readable media of claim 11, wherein the instructions, when executed by the at least one processor, further cause the at least one processor to perform the steps of:
receiving a second image and 3D information;
segmenting, using the first trained machine learning model and based on the first segmentation mask, the second image to generate a second segmentation mask;
determining an updated spatial representation of each object included in the one or more objects based on the second image, the 3D information, and the second segmentation mask; and
generating second program code using the third trained machine learning model and based on the updated spatial representation of each object, the second image, and the task; and
causing the robot to move based on the second program code.

17. The one or more non-transitory computer-readable media of claim 11, wherein the instructions, when executed by the at least one processor, further cause the at least one processor to perform the step of receiving natural language text describing the task.

18. The one or more non-transitory computer-readable media of claim 11, wherein generating the one or more descriptions comprises:
asking the second trained machine learning model to identify manipulable objects in the first image; and
asking the second trained machine learning model to describe each object included in the one or more objects.

19. The one or more non-transitory computer-readable media of claim 11, wherein the first trained machine learning model comprises a segmentation model, wherein the second trained machine learning model comprises a vision-language model, and wherein the third trained machine learning model comprises a multimodal model.

20. A system, comprising:
a memory storing instructions; and
one or more processors, that when executing the instructions, are configured to perform the steps of:
receiving an image,
segmenting, using a first trained machine learning model, the image to generate a segmentation mask,
generating one or more descriptions of one or more objects using a second trained machine learning model and based on the segmentation mask,
generating program code using a third trained machine learning model and based on the one or more descriptions, the image, and a task, and
causing a robot to move based on the program code.
